(19) United States
(12) Patent Application Publication
(10) Pub. No.: US 2010/0313978 A1
(43) Pub. Date: Dec. 16, 2010

(54) Pneumatic Valve Device

(76) Inventors: Chen-Hsing Yi, Dajia Town (TW); Yen-Hui Huang, Dajia Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/481,676

(22) Filed: Jun. 10, 2009

(51) Int. Cl. F16K 11/00

(52) U.S. Cl. 137/625

(57) ABSTRACT

A pneumatic valve device comprising an integral valve body having first, second, third, fourth, fifth, sixth and seventh openings; a regulation assembly for supplying gas in the second opening; a relief valve in the seventh opening; a pressure gauge in the sixth opening; and an inlet connector in the fifth opening. The first opening communicates with the second opening and the third opening respectively, the first opening has external threads releasably connected to a compressed gas cylinder, the third opening has one end communicating with an outside surface of the valve body and the other end communicating the regulation assembly, the fourth opening interconnects the compressed gas cylinder and the inlet connector, and the fifth opening, the sixth opening, and the seventh opening are equally spaced apart around an outer surface of the valve body and have the same elevation. The first, third and second openings communicate with each other.

### BACKGROUND OF THE INVENTION

1. Field of Invention

The invention relates to pneumatic valve device and more particularly to a pneumatic valve device for a compressed gas cylinder.

2. Description of Related Art

Compressed gas cylinders are widely used. A compressed gas cylinder having a pressure less than 800psi is often attached to a switch valve. A compressed gas cylinder having a pressure more than 4,500 psi is often attached to a pneumatic valve device. The pneumatic valve device is mounted for supplying compressed gas. However, the conventional pneumatic valve device has many openings. The openings are not at the same elevation. Each opening connects to an inner gas passage. Thus, conventional valve body is composed of two pieces but not formed as one piece. Furthermore, due to the conventional valve body is long and large, it will cause the problem of inconvenient assembling with the products and not durable because of the relatively large volume. In addition, the conventional pneumatic valve device comprises many components and it increases the manufacturing cost and results in short of competitiveness in the market. Thus, the need for improvement still exists.

### SUMMARY OF THE INVENTION

It is therefore one object of the invention to provide a pneumatic valve device comprising a valve body formed integrally, the valve body comprising a first opening, a second opening, a third opening, a fourth opening, a fifth opening, a sixth opening, and a seventh opening; a regulation assembly for supplying gas mounted in the second opening; a relief valve mounted in the seventh opening; a pressure gauge mounted in the sixth opening; and an inlet connector mounted in the fifth opening, wherein the first opening communicates with the second opening and the third opening respectively, the first opening has external threads releasably connected to a compressed gas cylinder, the third opening has one end communicating with an outside surface of the valve body and the other end communicating to a regulation assembly, the fourth opening interconnects the compressed gas cylinder and the inlet connector, and the fifth opening, the sixth opening, and the seventh opening are equally spaced apart around an outer surface of the valve body and have the same elevation; wherein the first opening connects to the third opening via a first passage, and the first opening connects to the second opening via a second passage so as to form a gas passage communicating with each other; and wherein the valve body further comprises a transverse aperture having one end terminated at the external threads of the first opening and the other end terminated at an inner surface of the first opening.

By utilizing the invention, the following advantages are obtained. The valve body in the present invention is formed integrally as one piece. The fifth opening, the sixth opening and the seventh opening are located at the same plane and have an included angle to one another. Three internally threaded bores are by way of the first passage and the second passage to communicate with each other to form a gas passage. Therefore, the valve body is formed integrally as one piece. The valve body in the present is smaller and more convenient and easier assembly with the products than conventional pneumatic valve device. In addition, the pneumatic valve device proposed by the present invention has a lower cost and fewer components than conventional pneumatic valve device. The invention will become more obvious from the following description when taken in connection with the accompanying drawings.

### BRIEF DESCRIPTION OF THE DRAWINGS

FIG. 1 is an exploded view of a preferred embodiment of a pneumatic valve device according to the invention;

FIG. 2 is a cross sectional view of the pneumatic valve device;

FIG. 3 a partially cross sectional view of the pneumatic valve device;

FIG. 4 is a front view of the valve body; and

FIG. 5 is a cross sectional view of the embodiment shown taken along line 5-5 of FIG. 4.

### DETAILED DESCRIPTION OF THE INVENTION

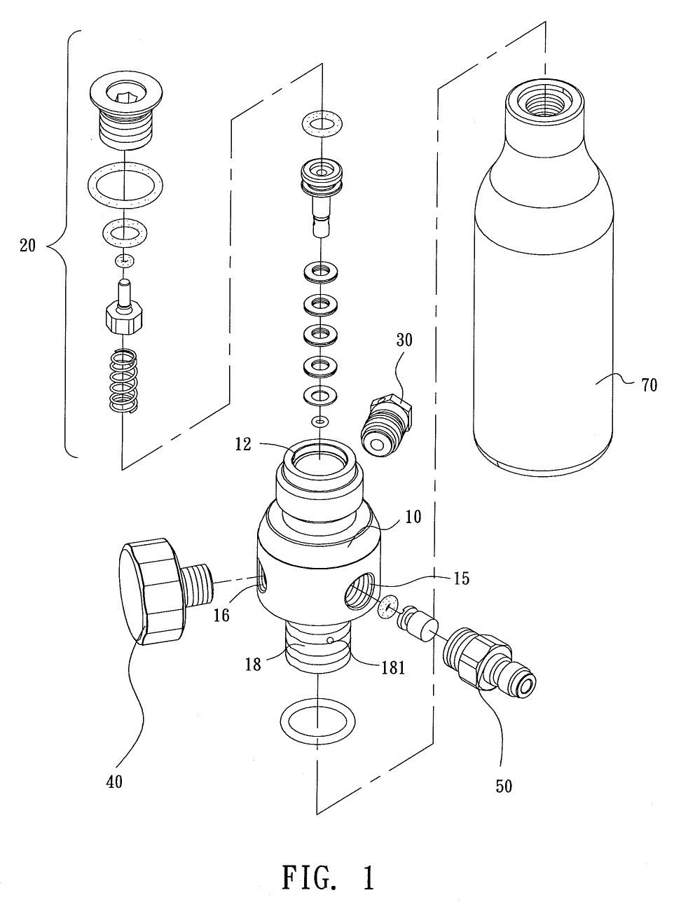

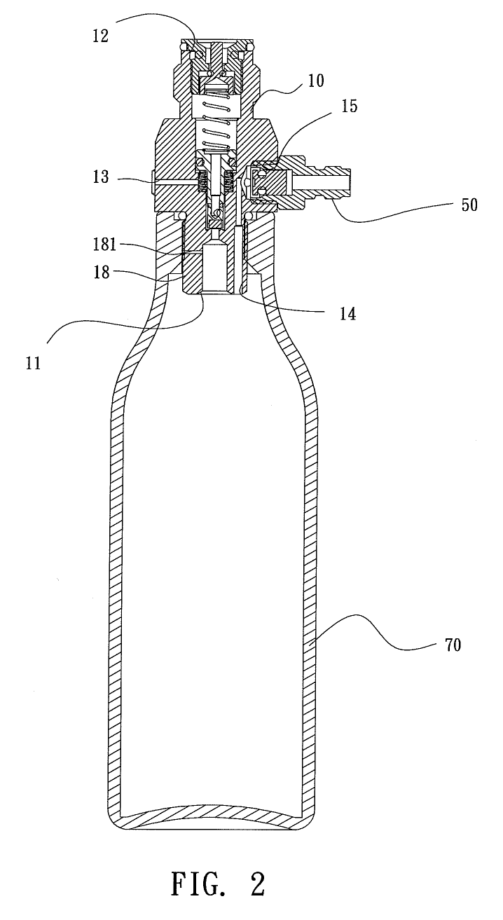

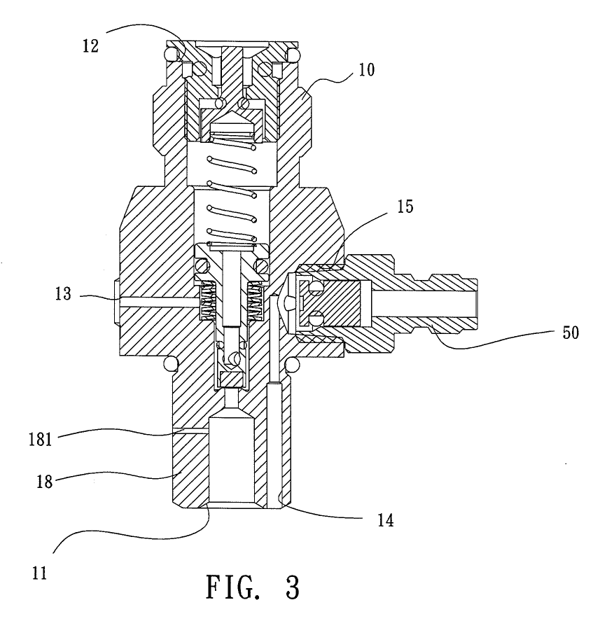

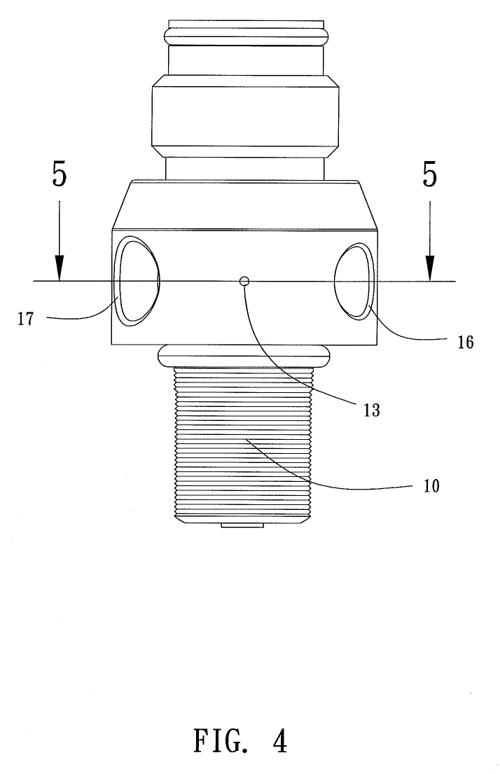

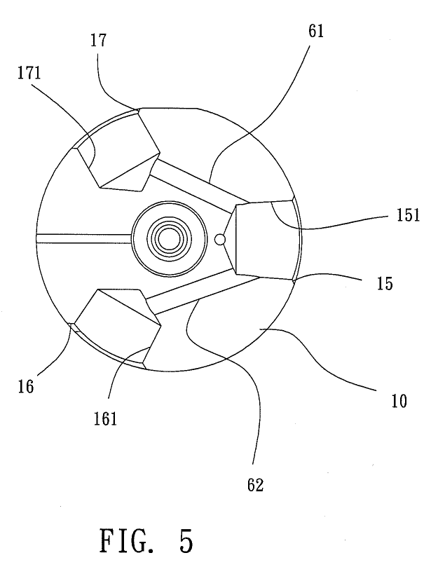

Referring to FIGS. 1 to 5, a pneumatic valve device which can supply constant and regulate pressure in accordance with a preferred embodiment of the invention is shown. The pneumatic valve device comprises a valve body 10 which is formed integrally, a regulation assembly 20, a relief valve 30 for protecting the valve body 10 from excessive pressure, a pressure gauge 40, and an inlet connector 50.

The valve body 10 comprises a first opening 11, a second opening 12, a third opening 13, a fourth opening 14, a fifth opening 15, a sixth opening 16, and a seventh opening 17. The first opening 11 communicates with the second opening 12 and the third opening 13 respectively. The first opening 11 connects to a compressed gas cylinder 70. The fourth opening 14 interconnects the compressed gas cylinder 70 and the fifth opening 15. The regulation assembly 20 is mounted in the second opening 12. Compressed gas is supplied through the second opening 12. The third opening 13 has one end communicating with an outside surface of the valve body 10 and the other end communicating with the regulation assembly 20. The inlet connector 50 is mounted in the fifth opening 15. The pressure gauge 40 is mounted in the sixth opening 16. The relief valve 30 is mounted in the seventh opening 17.

The fifth opening 15, the sixth opening 16, and the seventh opening 17 are equally spaced apart around an outer surface of the valve body 10 and have the same elevation. The fifth opening 15 has an internally threaded bore 151. The sixth opening 16 has an internally threaded bore 161. The seventh opening 17 has an internally threaded bore 171. The internally threaded bore 151 of the fifth opening 15 connects to the internally threaded bore 171 of the seventh opening 17 via a first passage 61 and the internally threaded bore 161 of the sixth opening 16 via a second passage 62 respectively so as to form a gas passage.

The valve body 10 further comprises a threaded section 18 on an outer surface of the first opening 11, and a transverse aperture 181 having one end terminated at the threaded section 18 and the other end terminated at the first opening 11. The threaded section 18 is threadedly connected to the compressed gas cylinder 70. Excessive pressure in the compressed gas cylinder 70 can be released through the aperture 181 so as to prevent the compressed gas cylinder 70 from explosion due to high pressure.

By utilizing the invention, the following advantages are obtained. The valve body 10 is formed integrally. The fifth opening 15, the sixth opening 16, and the seventh opening 17 are equally spaced apart around an outer surface of the valve body 10 and have the same elevation. The internally threaded bore 151 of the fifth opening 15 connects to the internally threaded bore 171 of the seventh opening 17 via the first passage 61 and the internally threaded bore 161 of the sixth opening 16 via the second passage 62 respectively so as to form a gas passage. Therefore, the valve body 10 can be made smaller and can be easier when assembling with the products as compared with the conventional pneumatic valve device. In addition, the pneumatic valve device of the invention is lower in the manufacturing cost and has fewer components than the conventional pneumatic valve device.

While the invention herein disclosed has been described by means of specific embodiments, numerous modifications and variations could be made thereto by those skilled in the art without departing from the scope and spirit of the invention set forth in the claims.

What is claimed is:

1. A pneumatic valve device comprising:
a valve body formed integrally and comprising a first opening, a second opening, a third opening, a fourth opening, a fifth opening, a sixth opening, and a seventh opening;
a regulation assembly for supplying gas mounted in the second opening;
a relief valve mounted in the seventh opening;
a pressure gauge mounted in the sixth opening; and
an inlet connector mounted in the fifth opening,
wherein the first opening communicates with the second opening and the third opening respectively, the first opening has external threads releasably connected to a compressed gas cylinder, the third opening has one end communicating with an outside surface of the valve body and the other end communicating the regulation assembly, the fourth opening interconnects the compressed gas cylinder and the inlet connector, and the fifth opening, the sixth opening, and the seventh opening are equally spaced apart around an outer surface of the valve body and have the same elevation;
wherein the first opening connects to the third opening via a first passage, and the first opening connects to the second opening via a second passage so as to form a gas passage communicating with each other; and
wherein the valve body further comprises a transverse aperture having one end terminated at the external threads of the first opening and the other end terminated at an inner surface of the first opening.
